(19) United States
(12) Patent Application Publication
(10) Pub. No.: US 2008/0120168 A1
(43) Pub. Date: May 22, 2008

(54) Method of promoting a selected business via a computerized system

(76) Inventor: David S. Hughes, Wheaton, IL (US)

Correspondence Address: DONALD G. FLAYNIK, JR.;CHERSKOV & FLAYNIK, 25208 W. REED ST., P.O. BOX 114, CHANNAHON, IL, 60410, US

(21) Appl. No.: 11/985,736

(22) Filed: Nov. 16, 2007

Related U.S. Application Data
(60) Provisional application No. 60/859,831, filed on Nov. 17, 2006.

(51) Int. Cl. G06Q 30/00

(52) U.S. Cl. 705/10; 705/14; 705/26

(57) ABSTRACT

A method for marketing, advertizing or promoting a selected business via a computerized system 10 includes selecting a business (block 12) for promotion in a selected geographical area (block 14); determining potential customers quantities for the selected business in the selected geographical area (block 16); disposing information pertaining to the selected business on a memory storage device or disc for computers (block 18); distributing multiple copies of the disc to business locations corresponding to the selected business within the selected geographical area (block 20); providing at least one copy of the disc to a customer at a business location corresponding to the selected business (block 22); providing a computerized system accessible via computers that receive information (an access code) from the copy of the disc (block 24); and inputting products and services into the computerized system (block 26).

This application is based on U.S. Provisional Application No. 60/859,831, filed ON Nov. 17, 2006.

### BACKGROUND OF THE INVENTION

1. Field of the Invention

The present invention relates generally to methods for promoting, marketing and/or advertising a business and, more particularly, to promoting a selected business in a selected geographical area via computers and/or a computerized system; the methods including advertising aimed at a predetermined customer base of sufficient quantity.

2. Background of the Prior Art

Advertising, marketing and promotional methods for businesses are necessary to achieve commercial success. Prior art methods have utilized mass marketing mediums such as television, newspapers and the “internet” which is accessed via personal computers. The problem with these prior art mediums is that there are large numbers of businesses being advertised, thereby resulting in potential customers overlooking a relatively small or “start-up” business as a source of needed goods and services. Further, prior art advertising methods do not provide adequate exposure of goods and services of small business or start-up business operating in a relatively small geographic area or in an area having a relatively small customer base.

A need exists for promoting and advertising goods and services of small and/or start-up businesses that require relatively inexpensive exposure in a relatively small area or in an area having a relatively small number of potential customers residing therein.

### SUMMARY OF THE INVENTION

It is a principle object of the present invention is to provide a method for promoting a selected business via a computerized system. A feature of the method is the selection of a business that satisfies a customer demand in a geographical area. An advantage of the method is that the business selected has a greater opportunity to succeed due to the existing customer needs.

Another object of the present invention is to provide a method that determines a potential customer base for a selected business in a selected geographical area. A feature of the method is to determined customer quantities based on parameters including but not limited to sex, race, age, occupation and recreational activities. An advantage of the method is that if insufficient customer quantities are determined, a different business or area is selected for promotion.

Yet another object of the present invention is to provide a method that disposes information pertaining to a selected business on a memory storage device for computers. A feature of the method is computer disc having sufficient storage capacity to receive information pertaining to the selected business. Another feature of the method is the distribution of multiple copies of the disc to a plurality of potential customers; the disc copies being procured by potential customers at existing business locations corresponding to the selected business in the selected area. An advantage of the method is that video and audio information pertaining to the selected business is displayed on a computer screen viewed by the potential customer of the selected business in the selected geographic area.

Still another object of the present invention is to provide a method that displays a plurality of computer discs in a business location corresponding to a selected business in a selected geographic area; the computer discs including information thereupon pertaining to the selected business. A feature of the method is a colorful and artistic designed package for each computer disc. Another feature of the method is an artistic kiosk that removably receives a plurality of the artistic packages with discs in each package. Still another feature of the method is that the kiosk is disposed proximate to a “check-out” station. Yet another feature of the method is that the artistic package and the disc therein are free to a potential customer. An advantage of the method is that a potential customer is enticed to take the free disc copy and the artistic package, thereby advertising the goods and/or services on the discs to the potential customers.

Another object of the present invention is to provide a method that includes a computerized system accessible via customer computers that receive information from a computer disc; the customer computers accessing the computerized system via telecommunication means. A feature of the method is an access code displayed on a portion of a package containing the computer disc. An advantage of the system is that a potential customer can access the computerized system only by procuring a computer disc, thereby being exposed to information on the disc that promotes and advertizes goods and/or services of a selected business in a selected geographic area.

Another object of the present invention is to provide a method that includes inputting goods and services pertaining to a selected business in a selected geographic area into a computerized system. A feature of the method is that the goods and services inputted into the computerized system are procurable via computers that receive information disposed on a computer disc. An advantage of the method is that the promoter of the selected business in the selected area, is compensated via the computerized system for selling and advertising the goods and services.

Briefly, the invention provides a method for promoting a selected business via a computerized system, said method comprising the steps of selecting a business for promotion; selecting a geographical area for promoting said selected business; determining potential customer quantities for said selected business within said selected geographical area; disposing information pertaining to said selected business on a memory storage device for computers, said memory storage device ultimately providing said disposed information to a computer utilized by customers of said selected business; distributing multiple copies of said memory storage device to business locations corresponding to said selected business within said defined geographical area; providing at least one memory storage device to a customer at said business locations corresponding to said selected business within said defined geographical area; providing a computerized system accessible via computers that received information from said copy of said memory storage device, said computerized system being accessible via telecommunication means; and inputting products and services pertaining to said selected business into said computerized system, the products and services being procurable via computers that receive information disposed on said memory storage device.

The invention further provides a system for selling products and services via computers comprising means for disposing information pertaining to products and services on a memory storage device for computers; means for distributing copies of said memory storage device to selected locations selling products and/or services corresponding to said disposed information on said memory storage device; means for promoting customer acquisition of said copies of said memory storage device a said selected locations; and a computer system accessible via computers that receive information from said copy of said memory storage device, said computer system including products and services for purchase via the computers that receive information from said memory storage device, the products and services for purchase corresponding to said information disposed on said memory storage device for computers.

### BRIEF DESCRIPTION OF THE DRAWINGS

These and other objects, advantages and novel features of the present invention, as well as details of an illustrative embodiment thereof, will be more fully understood from the following detailed description and attached drawings, wherein:

FIG. 1 is a flow chart of a method for promoting a selected business via a computerized system in accordance with the present invention.

### DESCRIPTION OF THE PREFERRED EMBODIMENT

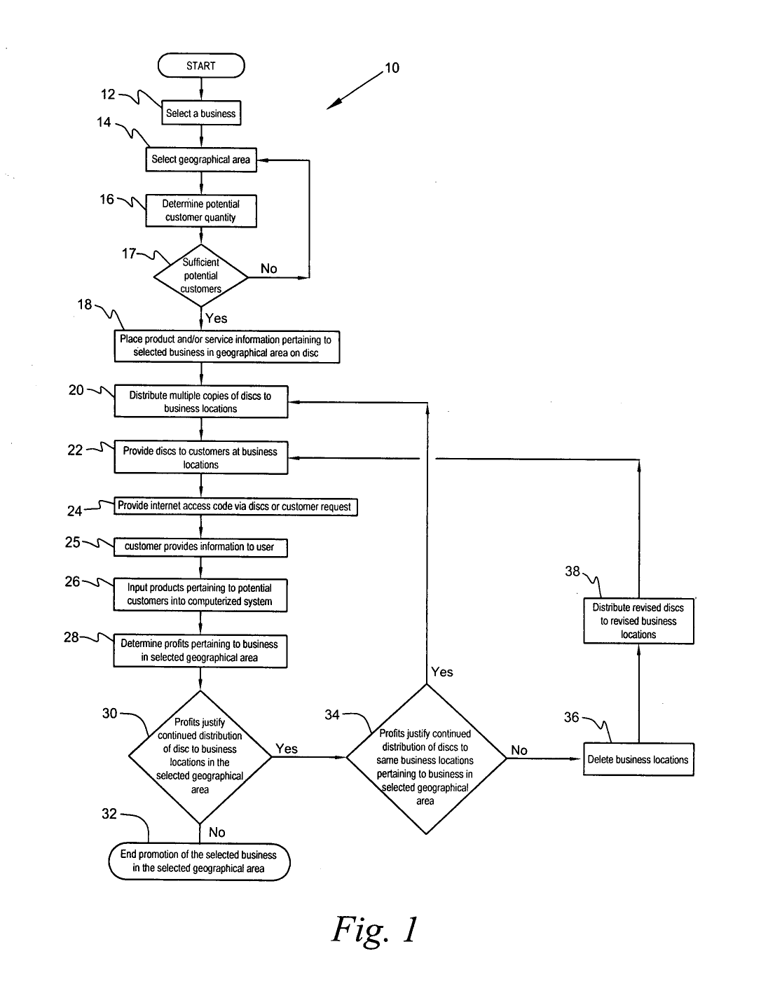

Referring now to FIG. 1, a method for marketing, advertising or promoting a selected business via a computerized system in accordance with the present invention is denoted as numeral 10. The method 10 includes selecting a business (block 12) for promotion in a selected geographical area (block 14); determining potential customer quantities for the selected business in the selected geographical area (block 16); disposing information pertaining to the selected business on a memory storage device or disc for computers (block 18); distributing multiple copies of the disc to business locations corresponding to the selected business within the selected geographical area (block 20); providing at least one copy of the disc to a customer at a business location corresponding to the selected business (block 22); providing a computerized system accessible via computers that receive information (an access code) from the copy of the disc or from a customer request via an internet site (block 24); and inputting products and services pertaining to the potential customers into the computerized system (block 26).

Referring to block 12 in FIG. 1, any business of interest to the marketer, promoter or user of the method 10 may be selected including, but not limited to, businesses pertaining to goods and/or services. Generally, the user will select a business (and corresponding goods and services) that satisfies a customer demand in a geographical area (block 14 in FIG. 1) proximate to the user's home; however, the primary objective of the method 10 is to select a business that is needed in a defined, limited area. Although the area 14 for the present method 10 can include a country or the entire world, the preferred scope of the area 14 is a village, town or city having an ascertainable customer base 16 for the selected business 12. In the event that an insufficient customer base is present for the selected geographical area (decision block 17), a different business 12 or area 14 must be selected. Typical parameters for determining a potential customer base or customer quantities include, but are not limited to sex, race, age, occupation and recreational activities.

Referring to block 18 in FIG. 1, upon selecting a business for an area with sufficient customer potential, information is disposed on a computer disc that will ultimately be inserted into a computer utilized by customers or potential customers of the selected business. The information disposed on the disc includes approximately a two hour video and audio presentation describing and/or depicting goods and services pertaining to the selected business, the goods and services being supplied by the user and/or third party suppliers selling corresponding goods and services. The provided information is intent on piquing the interest of potential customers to induce them to purchase the goods and/or services supplied, procured and/or offered by the selected business. The costs to dispose user and third party goods and services information on the first disc pertaining to the selected business in the selected area, are absorbed by the user of the method 10. The costs to dispose goods and services information on subsequent discs will be paid by the user and third party suppliers of the goods and services.

After disposing the information on the disc, multiple copies of the disc are fabricated or “burned” for distribution. Typically, a disc having a one gigabyte memory capacity is utilized to receive the goods and/or services information. The disc burning process is well known to those of ordinary skill in the art; however, after being burned, each disc for distribution is coated with a material that prevents the distributed disc from being copied for unintended use and distribution. The coating material is well known to those of ordinary skill in the art.

Referring to block 20 in FIG. 1, multiple copies of the disc are distributed to business locations (generally a store with aisles and a “check-out” or payment counter) corresponding to the selected business within the defined geographical area. The quantity of discs distributed to the selected business locations is typically one hundred, but may vary depending upon the customer base for that business location. Each disc is packaged in an enclosure with artistic designs and wording thereupon. The enclosures and discs therein, are disposed and displayed in an artistic kiosk that typically holds approximately one hundred discs. Upon delivering the kiosk and multiple copies of the discs in the enclosures to the business location, the discs are provided to customers (see block 22 in FIG. 1) by disposing the kiosk adjacent to a check-out counter for maximum customer exposure. Initially, the discs are free to both the store and customers, that is, one free disc per customer without charge. As the demand for the discs increases based on predetermined parameters that include sales and profit numbers for the store, the discs may be sold to the store for resale to the customers, or the discs may be provided to the store on a consignment basis with a sales price for each disc determined via negotiations between the promoter of the selected business and the store owner.

Referring to block 24 in FIG. 1, a computerized system is provided and is accessible via telecommunication means, or more specifically, an internet website is procured and configured, via means well known to those of ordinary skill in the art, to correspond to the selected business in the selected geographical area. The computerized system includes a purchased server computer that may be located proximate to the defined geographical area, or may include a remote server computer owned by a third party and licensed for use to the user of the present method 10. The website is accessed via an access code provided with the discs that are distributed to the selected business locations. Alternatively, the website may be accessed via passwords provided by a user of the present invention to a customer after the customer requests the passwords via a website window, and after the customer provides the user confidential customer information useful to the user to promote other user and/or third party goods and services that the customer might be interested in purchasing based upon the customer's confidential information (block 25). The discs provide the “key” to access a website having an expanded assortment of goods and services pertaining to the same selected business that the discs pertain to. The third party suppliers of goods and services depicted on the discs may or may not be named on the website. A third party supplier has the option of paying for the marketing of their goods and/or services on only the disc, only the website or on both the disc and website. Marketing or advertising payments correspond to the medium of presentation (disc or website), to the time of presentation of the goods and/or services on the respective medium, and to the costs to present the goods and/or services on the respective medium. The website has no “escape” hyper-links that would allow a customer to leave the user's website to purchase goods and services that do not provide the user compensation. Further, the customer's computer is protected from “viruses,” “worms,” and other software “attacks” while the customer is exploring the user's website.

The website includes but is not limited to a main “window” or “portal” providing general information or depictions of suppliers of goods and services pertaining to the selected business. The main window allows a customer that has accessed the website via the disc access code, to select any one of a plurality depictions pertaining to goods and services to evaluate whether or not the customer wishes to buy or otherwise procure the offered goods and services. Although the discs also provide information that allows a customer to decide if they want to purchase the marketed goods and services, the scope of information is much smaller and access to the information is much slower.

Referring to block 26 in FIG. 1, the products and/or services depicted on the website that pertain to potential customers are inputted to a computerized system that displays the website via means well known to those of ordinary skill in the art. The products and services are included on the website only after contracts between the user of the selected business, and the third party suppliers of the respective goods and services have agreed upon terms negotiated by the user and third party supplier. The contract includes provisions that detail the compensation paid to the usr for each good sold, each service provided and for each time a customer “surfing” or exploring the website “clicks on” a depiction displayed on the website provided by the user. Payments and/or commissions are made to the user by each third party supplier utilizing the user's website via computer means well known to those of ordinary skill in the art. Alternatively, payments to the user may be made by the customer after the customer clicks-on a depiction displayed on the website, but before the customer is allowed access to a predetermined portion of the computerized system that provides added displays corresponding to the clicked-on website depiction.

Referring to block 28 in FIG. 1, after providing the discs and “setting-up” the website, the usr must determined the profits pertaining to the selected business in the selected geographic area. After profits have been determined, the user must evaluate or determined if continued distribution of the discs to the selected business locations in the selected geographic area is justified (see decision block 30 in FIG. 1). If continued distribution is not justified, the marketing or promotion of the selected business in the selected geographic areas is ended (block 32 in FIG. 1). If profits justify the continued distribution of the discs in the area, then the user must determine the profits for each business location or store to determined if continued or periodic distribution of discs to a respective store is justified (decision block 34 in FIG. 1). If the continued distribution of discs to a respective store is justified, then revised discs with new or deleted information thereupon are distributed to the respective store or business location (block 20 in FIG. 1). If continued distribution of discs to a respective store is not justified, then the respective store is deleted from receiving discs (block 36 in FIG. 1). New business locations in the selected area are constantly selected and evaluated to determine if a customer base is present for the selected business (block 36 in FIG. 1). If a new business location or store is selected, then revised discs are distributed to the new business location (block 38 in FIG. 1). The new store then provides the revised discs to its customers (block 22 in FIG. 1). The method 10 for marketing or promoting the selected business in the selected area is then repeated.

In operation, a business minded person desiring to open a new business would utilize the present invention by first selecting a business that provides goods or services that he or she is interested in providing (block 12). For example, if a user of the invention was interested in an adult business product, the user might select exotic clothing to sell in a geographical area (blocks 12 and 14) that includes a large number of young adults (blocks 16 and 17). The exotic clothing could be manufactured by the user or supplied by the third parties having cooperating exotic clothing. User-third party contracts would be executed to insure that both the user and the third party supplier receive compensation. Next, the user would place a portion of their exotic clothing on a computer disc (block 18), make a relatively large quantity of duplicate discs (block 20), then distribute predetermined quantities of discs in stores of similar or related businesses, such as night clubs, taverns and/or adult book stores (blocks 20 and 22).

Next, the user would develop software that provides an internet site with customer access to the user's complete product line of exotic clothing. Customer access to the user's website would be achieved via the discs after insertion of a disc into a computer; or via a password provided by the user to a potential customer after the potential customer requests the password through the website (block 24), and after the customer provides the user confidential customer information (block 25) useful to the user to promote other user products that the customer might be interested in purchasing based upon the customer's confidential information (block 25). A complete user product line would be available to the customer via the website before the customer accesses the website, or the user's product line could be updated and/or increased after the customer provides his or her confidential information, thereby increasing the likelihood of a sale and a repeat customer via the computerized system (block 26).

The customer provided information may include, but is not limited to, physical and sexual profiles, education; interests in world news and events, sports, motor vehicles, models exhibiting exotic clothing, and business opportunities with the user. The customer may state their interests in uploading photos, a mailbox, social events, membership via the user and communicating with other members (block 25).

Next, the user determines the profits realized pertaining to the exotic clothing business in the selected geographical area (block 28). If the user does not generate sufficient profits from the exotic clothing operation in the selected area, the user discontinues the promotion of exotic clothing in the selected geographic area. The user focuses on the sale of exotic clothing in other areas or promotes a new product line in the selected geographic area (blocks 30 and 32). If the user does generate sufficient profits from the exotic clothing operation in the selected area, the user then determines if each separate business location receiving discs in the selected area should continue receiving replacement or revised discs (block 34) exhibiting exotic clothing. Individual business locations not producing sufficient profits do not continue receiving discs (block 36), and are replaced with new business locations (block 38). Individual business locations that do produce sufficient profits, keep receiving replacement or revised discs (block 20) exhibiting exotic clothing and possibly added goods and/or services that might appeal to the customer base of a successful business location.

The foregoing description is for purposes of illustration only and is not intended to limit the scope of protection accorded this invention. The scope of protection is to be measured by the following claims, which should be interpreted as broadly as the inventive contribution permits.

1. A method for promoting a selected business via a computerized system, said method comprising the steps of:
selecting a business for promotion;
selecting a geographical area for promoting said selected business;
determining potential customer quantities for said selected business within said selected geographical area;
disposing information pertaining to said selected business on a memory storage device for computers, said memory storage device ultimately providing said disposed information to a computer utilized by customers of said selected business;
distributing multiple copies of said memory storage device to business locations corresponding to said selected business within said defined geographical area;
providing at least one memory storage device to a customer at said business locations corresponding to said selected business within said defined geographical area;
providing a computerized system accessible via computers that received information from said copy of said memory storage device, said computerized system being accessible via telecommunication means; and
inputting products and services pertaining to said selected business into said computerized system, the products and services being procurable via computers that receive information disposed on said memory storage device.

2. The method of claim 1 wherein the step of disposing information pertaining to a selected business on a memory storage device includes the step of providing a computer disc.

3. The method of claim 1 wherein the step of disposing information on said memory storage device includes the step of inputting video and audio information on said memory storage device.

4. The method of claim 1 wherein the step of determining potential customer quantities includes population, sex, race and age of a customer base for said defined geographical area for promoting said selected business.

5. The method of claim 1 wherein the step of distributing multiple copies of said memory storage device includes the step of providing free computer discs to the business locations for distribution to customers at no charge.

6. The method of claim 1 wherein the step of distributing multiple copies of said memory storage device includes the step of selling computer discs to the business locations for distribution to customers at an agreed upon sales price.

7. The method of claim 1 wherein the step of distributing said memory storage device includes the step of selling a plurality of computer discs to the business locations after predetermined parameters have been achieved by the business locations.

8. The method of claim 7 wherein said predetermined parameters include sales and profit numbers.

9. The method of claim 1 wherein the step of providing said memory storage device to customers at the business locations includes the step of disposing a plurality of said memory storage device at a business location payment counter.

10. The method of claim 1 wherein the step of providing a computerized system includes the step of providing at least one server at a location proximate to said defined geographical area.

11. The method of claim 1 wherein the step of providing a computerized system includes the step of compensating a user of said computerized system.

12. The method of claim 1 wherein the step of disposing information pertaining to the selected business on a memory storage device includes the step of selling memory storage space on said memory storage device to third party suppliers.

13. The method of claim 1 wherein the step of disposing information pertaining to the selected business on a memory storage device includes the step of initially providing free memory storage space on said memory storage device to third party suppliers.

14. The method of claim 1 wherein the step of inputting products and services includes the step of inputting third party supplier products and services corresponding to said information disposed on said memory storage device.

15. The method of claim 11 wherein the step of compensating a user of said computerized system includes the step of procuring agreements with third party suppliers of products and services ultimately procured by customers of said user via said computerized system provided by said user.

16. The method of claim 11 wherein the step of compensating a user of said computerized system includes the step of requiring payment from a customer before the customer is allowed access to a predetermined portion of said computerized system.

17. The method of claim 11 wherein the step of compensating a user of said computerized system includes the step of paying the user via said computerized system.

18. The method of claim 1 wherein the step of distributing multiple copies of said memory storage device includes the step distributing multiple copies of said memory storage device with revised information thereupon.

19. A system for selling products and services via computers comprising:
means for disposing information pertaining to products and services on a memory storage device for computers;
means for distributing copies of said memory storage device to selected locations selling products and/or services corresponding to said disposed information on said memory storage device;
means for promoting customer acquisition of said copies of said memory storage device at said selected locations; and
a computer system accessible via computers that receive information from said copy of said memory storage device, said computer system including products and services for purchase via the computers that receive information from said copy of said memory storage device, the products and services for purchase in said computer system corresponding to said information disposed on said memory storage device for computers.

20. A method for selling products and/or services via computers, said method comprising the steps of:
disposing preselected goods and/or service information on computer discs;
distributing said computer discs at businesses locations selling corresponding goods and/or services;
urging customers at said business locations to take one of said computer discs;
providing a computer system accessible via computers receiving said computer disc, said computer system including goods and services purchasable via the computers receiving said computer disc, the goods and services purchasable from said computer system being comparable to the goods and/or service information disposed on said computer discs; and
evaluating each business location to determined if profits resulting from the sale of goods and/or services promoted by said computer discs at an evaluated business location warrant continued distribution of said computer discs to the evaluated business location.
